(19) United States
(12) Patent Application Publication
(10) Pub. No.: US 2007/0083405 A1
(43) Pub. Date: Apr. 12, 2007

(54) Market-driven design of information technology components

(76) Inventors: Michael W. Britt, Rochester, MN (US); Thomas D. Christopherson, Rochester, MN (US); Mark A. Pasch, Rochester, MN (US); Christopher H. Wicher, Raleigh, NC (US); Patrick M. Wildt, Rochester, MN (US)

Correspondence Address: MARCIA L. DOUBET LAW FIRM, PO BOX 422859, KISSIMMEE, FL, 34742, US

(21) Appl. No.: 11/244,644

(22) Filed: Oct. 6, 2005

(51) Int. Cl. G06F 17/50

(52) U.S. Cl. 705/7

(57) ABSTRACT

Techniques for designing information technology components by influencing design of a component using a set of criteria that reflect requirements of a target market. Each of the criteria may have one or more attributes, and may be different in priority from one another. The criteria are preferably directed toward ensuring, and/or improving, the component's acceptance by its target market. Preferably, a component assessment process is used to determine whether the assessed component will meet requirements of its target market; if deficiencies are found, the component (or supporting information such as documentation) can then be redesigned.

### CROSS-REFERENCE TO RELATED APPLICATIONS

The present application is related to the following commonly-assigned and co-pending U.S. Patent Applications, which were filed concurrently herewith: Ser. No. 10/______, which is titled “Assessing Information Technology Components”; Ser. No. 10/______, which is titled “Role-Based Assessment of Information Technology Packages”; and Ser. No. 10/______, which is titled “Selecting Information Technology Components for Target Market Offerings”. The first of these related applications is referred to herein as “the component assessment application”. The present application is also related to the following commonly-assigned and co-pending U.S. Patent Applications, all of which were filed on May 16, 2003 and which are referred to herein generally as “the related applications”: Ser. No. 10/612,540, entitled “Assessing Information Technology Products”; Ser. No. 10/439,573, entitled “Designing Information Technology Products”; Ser. No. 10/439,570, entitled “Information Technology Portfolio Management”; and Ser. No. 10/439,569, entitled “Identifying Platform Enablement Issues for Information Technology Products”.

### BACKGROUND OF THE INVENTION

The present invention relates to information technology (“IT”) , and deals more particularly with designing IT components in view of market requirements.

As information technology products become more complex, developers thereof are increasingly interested in use of software component engineering (also referred to as “IT component engineering”) . Software component engineering focuses, generally, on building software parts as modular units, referred to hereinafter as “components”, that can be readily consumed and exploited by a higher-level software packaging or offering (such as a software product), where each of the components is typically designed to provide a specific functional capability or service.

Software components (referred to equivalently herein as “IT components” or simply “components”) are preferably reusable among multiple software products. For example, a component might be developed to provide message logging, and products that wish to include message logging capability may then “consume”, or incorporate, the message logging component. This type of component reuse has a number of advantages. As one example, development costs are typically reduced when components can be reused. As another example, end user satisfaction may be increased when the user experiences a common “look and feel” for a particular functional capability, such as the message logging function, among multiple products that reuse the same component.

When a sufficient number of product functions can be provided by component reuse, a development team can quickly assemble products and solutions that produce a specific technical or business capability or result.

One approach to component reuse is to evaluate an existing software product to determine what functionality, or categories thereof, the existing product provides. This approach, which is commonly referred to as “functional decomposition”, seeks to identify functional capabilities that can be “harvested” as one or more components that can then be made available for incorporating into other products.

However, functional decomposition has drawbacks, and mere existence of functional capability in an existing product is not an indicator that the capability will adapt well in other products or solutions.

### BRIEF SUMMARY OF THE INVENTION

The present invention provides techniques for designing IT components. In one preferred embodiment, this comprises: determining a plurality of criteria that are important to a target market, and at least one attribute to be used for measuring each of the criteria; specifying objective measurements for each of the attributes, thereby identifying values that are assignable to each attribute from a multi-valued scale; specifying prescriptive statements that identify, for at least one of the attributes, actions required to achieve at least one of the identified values from the multi-valued scale; and using the specified prescriptive statements to determine what functionality to include in an IT component. This may further comprise conducting an evaluation of the IT component, and if the computed assessment score fails to meet a predetermined threshold, revising the IT component to improve the computed assessment score. Conducting the evaluation may further comprise: inspecting a representation of the IT component, with reference to selected ones of the attributes; assigning attribute values from the multi-valued scale to the selected attributes, according to how the IT component compares to the specified objective measurements; and using the assigned attribute values to compute an assessment score for the component.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will now be described with reference to the following drawings, in which like reference numbers denote the same element throughout.

### BRIEF DESCRIPTION OF THE SEVERAL VIEWS OF THE DRAWINGS

FIG. 1 provides an overview of a component design approach, according to preferred embodiments of the present invention;

FIG. 2 provides a chart summarizing a number of sample criteria and attributes for software with regard to particular market requirements;

FIG. 3 depicts example rankings showing the relative importance of requirements for IT purchasers in a sample target market segment;

FIG. 4 shows an example of textual descriptions that may be defined to assist component assessors in assigning values to attributes in a consistent, objective manner;

FIG. 5 provides a flowchart that illustrates, at a high level, actions that are preferably carried out when establishing an assessment process according to the component assessment application;

FIG. 6 (comprising FIGS. 6A - 6C) contains a sample questionnaire, of the type that may be used to solicit information from a development team whose IT component will be assessed;

FIG. 7 describes performing a component assessment in an iterative manner;

FIG. 8 provides a flowchart that depicts details of how a component assessment may be carried out;

FIG. 9 depicts an example of how two different component assessment scores may be used for assigning special designations to assessed components; and

FIG. 10 illustrates a sample component assessment report where two aspects of a component have been assessed and scored, and FIG. 11 shows a sample component assessment summary report.

### DETAILED DESCRIPTION OF THE INVENTION

The present invention provides techniques for market-driven design of IT components. This design approach may be referred to as a “market requirements decomposition approach” to component design. (The terms “component design” and “component development” are used interchangeably herein.) Market requirements-oriented decomposition, as disclosed herein, provides planners, designers, and/or developers with a context and priority information for use in making component selection and design trade-off, and enables selecting which componentization efforts may be most beneficial with limited resource investment. Using this market requirements-oriented approach facilitates providing components that improve market acceptance for consuming applications in a particular target market. Furthermore, limitations that are inherent in the functional decomposition approach to component identification and development may be alleviated using the market requirements decomposition approach.

As noted earlier, the functional decomposition approach has drawbacks when creating software components by harvesting functionality from existing products. As one example, a drawback of the functional decomposition approach is that no consideration is generally given during the decomposition process as to how the harvested component(s) will ultimately be used, or to the results achieved from such use. This may result in the creation of components that do not achieve their potential for reuse and/or that fail to satisfy requirements of their target market or target audience of users. Suppose a message logging capability is identified as a reusable component during functional decomposition, for example. If the code providing that message logging capability performs inefficiently or has poor usability, then these disadvantages will be propagated to other products that reuse the message logging component. As another example, a functional capability for providing an administrative interface within a product might be identified as a potential component for harvesting. However, it may happen that the code providing this administrative interface capability has a number of inhibitors that would be detrimental when the code is consumed by other products.

In addition, because it seeks to break down already-existing code into components, the functional decomposition approach does not seek to provide components that are designed specifically to satisfy particular market requirements or market requirements which may be of most importance in the target market.

The related application entitled “Designing Information Technology Products” (Ser. No. 10/439,573) defines techniques for designing a product as a whole. The present invention extends the teachings of this related application, enabling component-level focus on achieving market requirements. In this manner, potential for component reuse can be increased, and the likelihood of providing components that achieve the requirements of the target market can be improved. Optionally, functional decomposition can be used in concert with market-driven design techniques disclosed herein. If the functional decomposition identifies functional capabilities that overlap with those identified using market-driven techniques, this is an indication of functionality with a high potential for reuse as a component to be provided (for example) as part of a component toolkit.

In preferred embodiments, the present invention provides techniques for designing IT components in view of a set of criteria that are designed to ensure the component's success at addressing requirements of a target market, and each of these criteria has one or more attributes.

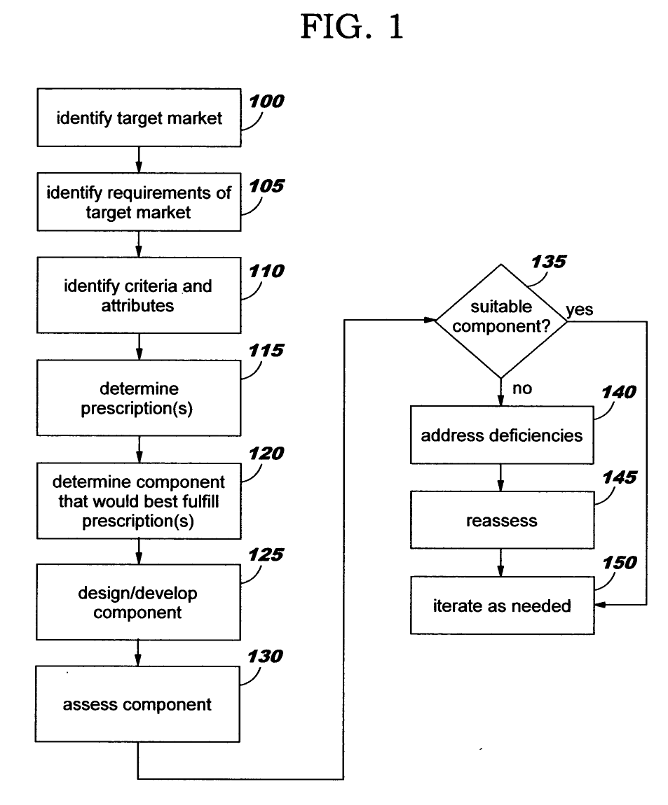

Referring now to FIG. 1, an overview is provided of a component design approach according to preferred embodiments of the present invention. As shown therein at Block 100, a target market or market segment is identified. (The terms “target market” and “market segment” are used interchangeably herein.) Custom information about the types of users and/or businesses that are potential buyers of products in the target market. Such profiles may provide a better understanding of the target market.

Requirements of the identified target market are also identified (Block 105). As discussed in the related applications, a number of factors may influence whether an IT product is successful with its target market, and these factors may vary among different segments of the market Accordingly, the requirements that are important to the target market are used in designing components to be provided in products and solutions (referred to herein more generally as “products”) to be marketed therein.

Criteria of importance to the target market, and attributes pertaining thereto, are identified (Block 110) for use in the component development process. Multiple attributes may be defined for any particular requirement, as deemed appropriate. High-potential attributes may also be identified.

As one example, if an identified requirement is “reasonable footprint”, then an attribute may be defined such as “requires less than . . . [some amount of storage]”; or, if an identified requirement is “easy to learn and use”, then an attribute may be defined such as “novice user can use functionality without reference to documentation”. Degrees of support for particular attributes may also be specified. For example, an attribute of the “easy to learn and use” requirement might be specified as “novice user can successfully use X of 12 key function on first attempt”, where the value of “X” may be expressed as “1-3”, “4-6”, “7-9”, and so forth.

Market segments may be structured in a number of ways. For example, a target market for an IT product may be segmented according to industry. As another example, a market may be segmented based upon company size, which may be measured in terms of the number of employees of the company. The manner in which a market is segmented does not form part of the present invention, and techniques disclosed herein are not limited to a particular type of market segmentation. Furthermore, the attributes of importance to a particular market segment may vary widely, and embodiments of the present invention are not limited to use with a particular set of attributes. Attributes discussed herein should therefore be construed as illustrating, but not limiting, use of techniques of the present invention.

In Block 115, objective means for determining satisfaction of each criterion—or, alternatively, of each attribute—are determined. These objective means are also referred to herein as a “prescription” or “prescriptive attribute specification”, and provide a list or set of market-specific goals to be provided to component developers, thereby enabling a prescriptive approach to component development. For example, a prescriptive statement might be specified such as “component will score a ‘5’ on ‘Easy to Learn and Use’ criterion if: (1) samples are provided for all exposed end-user functions; (2) all key functions can be learned by novice user within 2 attempts; . . .”. Identifying one or more such goals for each of the criteria/attributes provides a structured approach for ensuring that key actions will be taken to achieve satisfaction of the identified market requirements, thus enabling components created according to the present invention to improve market acceptance of their consuming products. (Component scoring with regard to a numeric scale, and computing a component assessment score, is discussed in more detail below.)

As noted in Block 120, the prescription(s) which were identified in Block 115 are used to determine a component that would best fulfill the prescription(s), in order to develop an enabling component that can be used by others and that specifically addresses the identified market requirements. (More than one component may be identified for fulfilling a prescription or prescriptions, alternatively.) For example, if one of the prescriptions is that the installation process should be seamless and guided, then it is advantageous to determine how to achieve this in a consistent manner. Use of a launchpad, introductory first steps, and getting-starting wizards are three types of components that might be used to enable satisfaction of the prescription for seamless and guided installation.

A prioritization process is preferably used when determining which component(s) to design and develop, whereby the design/development team can determine which component for each attribute should be addressed first. Preferably, a formulaic approach is used whereby the importance of each attribute in the target market, based on information determined according to Blocks 100 and 105, is considered along with the feasibility of implementing each particular component. For example, if the market information indicates that ease of installation is a high-ranking attribute, but a component to address this attribute would be extremely difficult to implement, then these factors may be considered in deciding whether components that address other attributes should be prioritized higher.

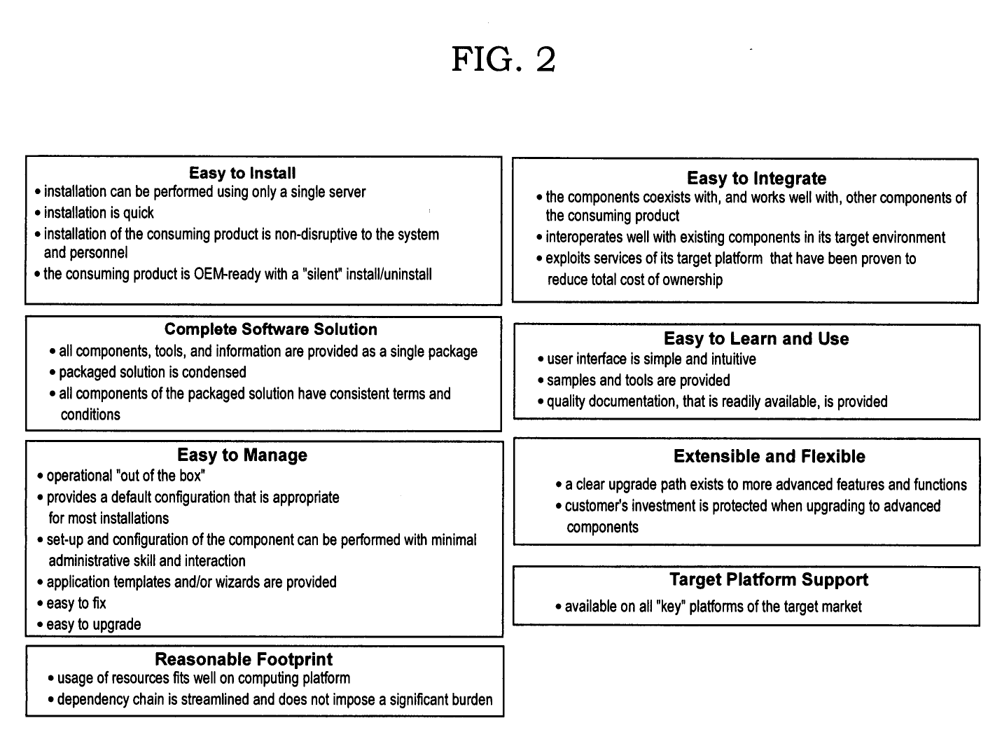

Refer to FIG. 2, where a chart is provided that summarizes a number of criteria and attributes pertaining to market requirements of a hypothetical target market, by way of example. These criteria and attributes will now be described in more detail.

Easy to Install.

This criterion measures how easily the consuming product of the component is installed in its intended market. Attributes used for this measurement may include: (i) whether the installation can be performed using only a single server; (ii) whether installation is quick (e.g., measurable in minutes, not hours); (iii) whether installation is non-disruptive to the system and personnel; and (iv) whether the package is OEM-ready with a “silent” install/uninstall (that is, whether the package includes functionality for installing and uninstalling itself without manual intervention).

Complete Software Solution.

This criterion judges whether the consuming product of the component provides a complete software solution for its users. Attributes may include: (i) whether all components, tools, and information needed for successfully implementing the consuming product are provided as a single package; (ii) whether the packaged solution is condensed—that is, providing only the required function; and (iii) whether all components of the packaged solution have consistent terms and conditions (sometimes referred to as “T's and C's”) .

Easy to Integrate.

This criterion is used to measure how easy it is to integrate the component with other components. Attributes used in this comparison may include: (i) whether the component coexists with, and works well with, other components of the consuming product; (ii) whether the component interoperates well with existing components in its target environment; and (iii) whether the component exploits services of its target platform that have been proven to reduce total cost of ownership.

Easy to Manage.

This criterion measures how easy the component is to manage or administer, if applicable. Attributes defined for this criterion may include: (i) whether the component is operational “out of the box” (e.g., as delivered to the developer, when provided as a reusable component of a development toolkit); (ii) whether the component, as delivered, provides a default configuration that is appropriate for most installations; (iii) whether the set-up and configuration of the component can be performed with minimal administrative skill and interaction; (iv) whether application templates and/or wizards are provided to simplify use of the component and its more complex tasks; (v) whether the component is easy to fix if defects are found; and (vi) whether the component is easy to upgrade.

Easy to Learn and Use.

Another criterion to be measured is how easy it is to learn and use the component. Attributes for this measurement may include: (i) whether the component's user interface is simple and intuitive; (ii) whether samples and tools are provided, in order to facilitate a quick and successful first-use experience; and (iii) whether quality documentation, that is readily available, is provided.

Extensible and Flexible.

Another criterion used is the component's extensibility and flexibility. Attributes used for this measurement may include: (i) whether a clear upgrade path exists to more advanced features and functions; and (ii) whether the customer's investment is protected when upgrading to advanced components or versions thereof.

Reasonable Footprint.

For many IT markets, the availability of computing resources such as storage space and memory usage is considered to be important, and thus a criterion that may be used for components is whether the component has a reasonable footprint. Attributes may include: (i) whether the component's usage of resources such as random-access memory (“RAM”) , central processing unit (“CPU”) capacity, and persistent storage (such as disk space) fits well on a computing platform used in the target environment; and (ii) whether the component's dependency chain is streamlined and does not impose a significant burden.

Target Market Platform Support

Finally, another criterion used for components with regard to the target market may be platform support. An attribute used for this purpose may be whether the component is available on all “key” platforms of the target market. Priority may be given to selected platforms.

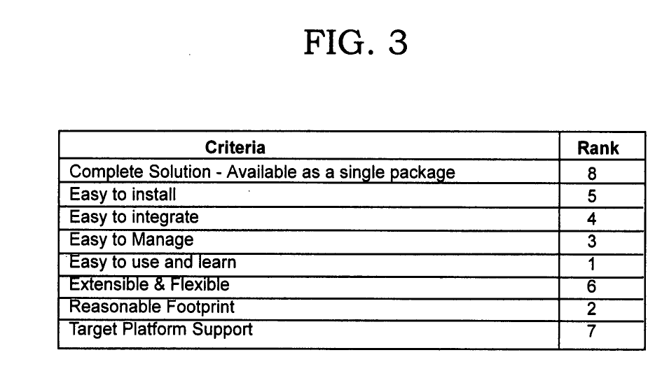

The particular criteria to be used for a particular component, and attributes used for those criteria, are preferably determined by market research that analyzes what factors are significant to people making IT purchasing decisions. Preferred embodiments of the design process disclosed herein use these criteria and attributes as a framework for determining what components to create and the functionality capabilities of those components. In addition, other factors such as service and support for the capabilities of a component may be addressed as well. The market research preferably also includes an analysis of how important the various factors are in the purchasing decision. Therefore, preferred embodiments of the present invention allow weights to be assigned to attributes and/or criteria, enabling them to have a variable influence on prioritizing inclusion of capabilities in components. These weights preferably reflect the importance of the corresponding attribute/criteria to the target market. Accordingly, FIG. 3 provides sample rankings with reference to the criteria in FIG. 2, showing the relative importance of these factors for IT purchasers in a hypothetical market segment.

It should be noted that the attributes and criteria that are important to IT purchasing decisions may change over time. In addition, the relative importance thereof may change. Therefore, embodiments of the present invention preferably provide flexibility in the design process and, in particular, in the attributes and criteria that are measured, in how the measurements are weighted, and/or in how this information is used to select and/or prioritize aspects of components.

Referring again to FIG. 1, one or more components can then be designed and developed (Block 125) to meet the market requirements, using the prescriptive statements as guidelines during the design and/or development process.

A goal of the approach depicted in FIG. 1 is to design and develop components that will achieve their potential for reuse and will satisfy particular requirements of their identified target market or target audience of users. Using techniques disclosed herein, component teams consider how the components will ultimately be used, and the results to be achieved from such use, and can create components by transforming the identified market requirements into component characteristics. Preference may be given to market requirements which are of most importance in the target market. Through this market-driven component design approach, consuming products can be quickly assembled to provide a solution in a particular design space or target market. Furthermore, components designed and developed according to the present invention are less likely to be detrimental when the code is consumed by other products.

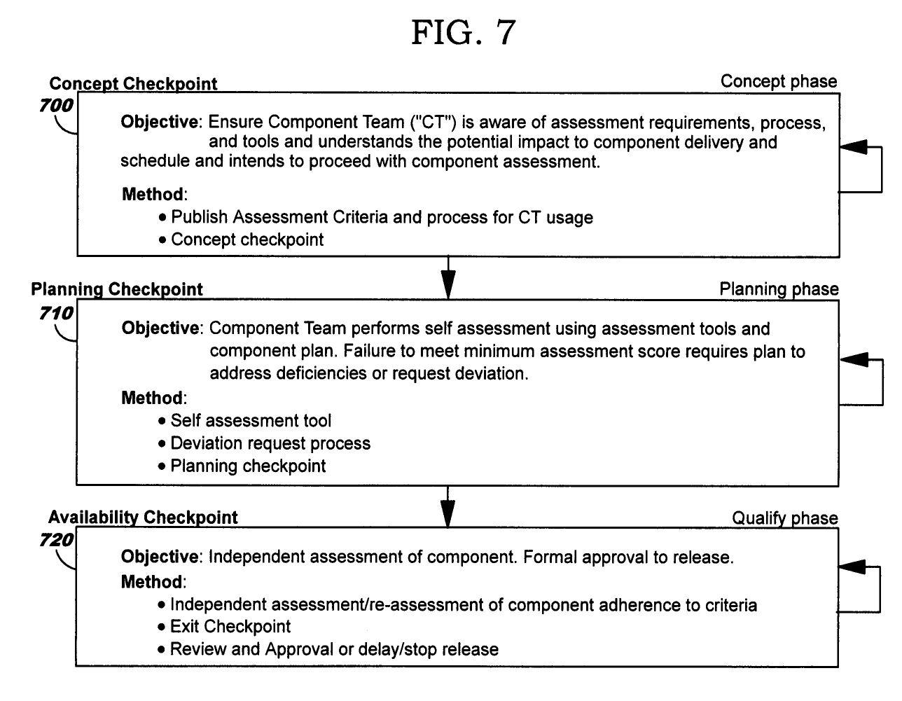

Preferably, techniques from the component assessment application are leveraged when designing components. Accordingly, the assessment process disclosed in the component assessment application is discussed herein by way of reference. A goal of assessing components created using techniques of the present invention is to validate their satisfaction of market requirements. Block 130 therefore indicates that an assessment of the developed component is preferably carried out with regard to the measurement criteria As an alternative, an assessment may be conducted on a component plan or component design, in which case the assessment is preferably conducted prior to Block 125. (Refer to the discussion of FIG. 7, which addresses component assessment for plans and designs as well as for actual components.)

Following the assessment, a test is made at Block 135 as to whether the assessment results indicate that this is a suitable component. This test preferably comprises comparing a numeric component assessment score to a predetermined threshold. Assessment results, and how those results can be used to determine whether a component is suitable, will be discussed in more detail below. If the test at Block 135 is negative, then deficiencies identified during the assessment process are addressed (Block 140). For example, it might be determined that the functionality of the component fails to meet a critical requirement, and thus the component needs to be modified before becoming a reusable component. Or, it might be determined that a component yet to be developed needs redesign in selected areas.

Following Block 135, a reassessment is preferably conducted (Block 145). The operations depicted in FIG. 1 may then iterate, as needed, as indicated in Block 150.

As will be obvious, development of more than one component can be performed at Block 120, and the subsequent processing depicted in FIG. 1 then applies to these multiple components.

Designing components using the approach shown in FIG. 1 and described herein improves the likelihood that the consuming product or solution will be viewed as useful to a particular target market. In addition, this market-driven approach seeks to ensure that components include features to support requirements which have been identified for the target market and that the components are not detrimental to consuming products.

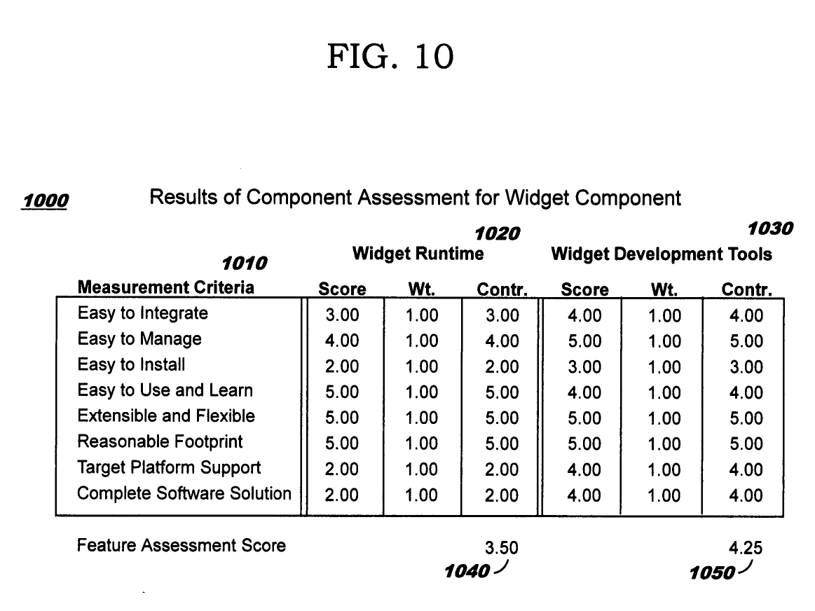

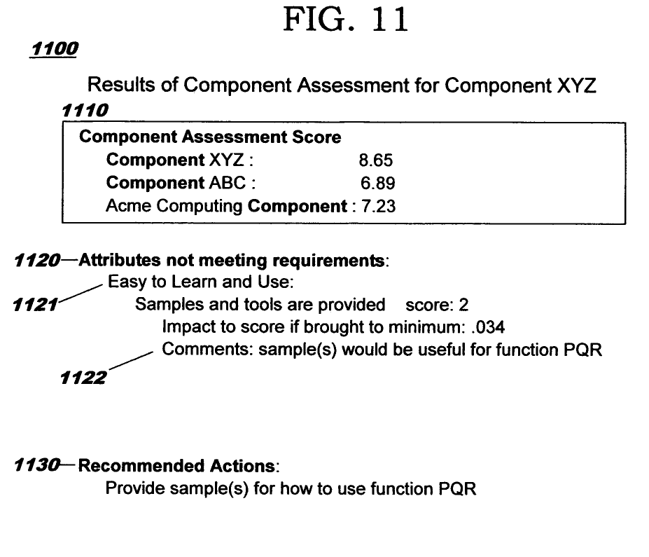

By using the framework of the present invention with its well-defined and objective measurement criteria and attributes, and its objective checkpoints, the component design process can be guided and focused for creating components intended for consuming products of a target market. (This will be described in more detail below. See, for example, the discussion of FIG. 10, which presents a sample component assessment report that may be used to predict how well a component will meet requirements of its target market.)

Preferably, numeric values such as a scale of 1 to 5 are used when measuring each of the attributes during the assessment process. In this manner, relative degrees of support (or non-support) can be indicated. (Alternatively, another scale, such as 0 to 5, might be used.) In the examples used herein, a value of 5 indicates the best case, and 1 represents the worst case. As disclosed in the component assessment application, textual descriptions are preferably provided for each numeric value of each attribute, where these textual descriptions are designed to assist component assessors in performing an objective, rather than subjective, assessment Preferably, the textual descriptions are defined so that a component being assessed will receive a score of 3 on an attribute if the component meets the market's expectation for that attribute, a score of 4 if the component exceeds expectations, and a score of 5 if the component greatly exceeds expectations or sets new precedent for how the attribute is reflected in the component. On the other hand, the descriptions are preferably defined so that a component that meets some expectations for an attribute (but fails to completely meet expectations) will receive a score of 2 for that attribute, and a component that obviously fails to meet expectations for the attribute (or is considered obsolete with reference to the attribute) will receive a score of 1.

Techniques of the present invention are described herein with reference to particular criteria and attributes developed with reference to requirements for a hypothetical target market, as well as with reference to a component assessment score that is expressed as a numeric value. However, it should be noted that these descriptions are by way of illustrating use of the novel techniques of the present invention, and should not be construed as limiting the present invention to these examples.

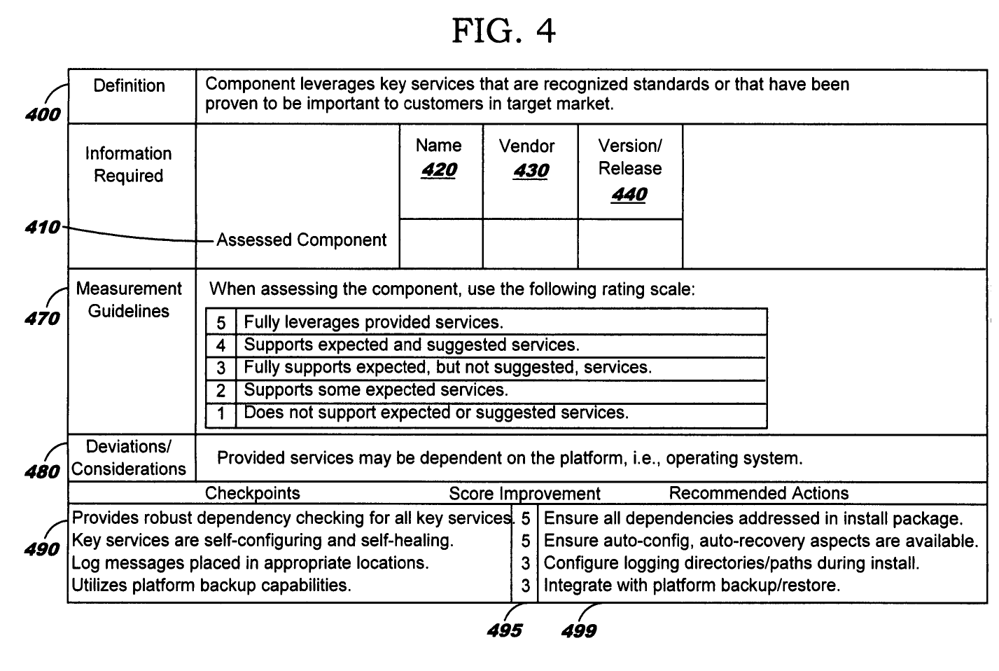

FIG. 4 provides an example of the textual descriptions that may be used to assign a value to the “exploits services of its target platform that have been proven to reduce total cost of ownership” attribute of the “Easy to Integrate” criterion that was stated above, and is representative of an entry from an evaluation form or workbook that may be used during a component assessment. As illustrated in FIG. 4, a definition 400 is preferably provided to explain the intent of this attribute to the component assessment team. (The information illustrated in FIG. 4 may be used during a component assessment carried out by a component assessment team, and/or by a component development team that wishes to determine how well its component will be assessed.)

A component name and vendor (see elements 420, 430) may be specified, along with version and release information (see element 440) or other information that identifies the particular component under assessment.

A set of measurement guidelines (see element 470) is preferably provided as textual descriptions for use by the component assessors. In the example, a value of 3 is assigned to this attribute if the component fully supports a set of “expected” services, but fails to support all “suggested” services. A value of 5 is assigned if the assessed component fully leverages all of the provided (i.e., expected as well as suggested) services, whereas a value of 1 is assigned if the component fails to support the expected services and the suggested services. If the assessed component supports (but does not fully leverage) expected and suggested services, then a value of 4 is assigned. And, if the assessed component supports some of the expected services, then a value of 2 is assigned. (What constitutes an “expected service” and a “suggested service” may vary widely from one component to another and/or from one target market to another.)

Element 480 indicates that an optional feature of the component assessment process allows per-attribute deviations when assigning values to attributes for the assessed component In this example, the deviation information explains that the provided services may be dependent on the platform(s) on which this component will be used.

One or more checkpoints and corresponding recommended actions may also be provided. See elements 490 and 499, respectively, where sample checkpoints and actions have been provided for this attribute. In addition, a set of values may be specified to indicate how providing each of these will impact or improve the component's assessment score. See element 495, where sample values have been provided. The information shown at 490 - 499 may be used, for example, when developing prescriptive statements of the type discussed earlier with reference to Block 115 of FIG. 1.

Information similar to that depicted in FIG. 4 is preferably created for measurement guidelines to be used by component assessors when assessing each of the remaining attributes.

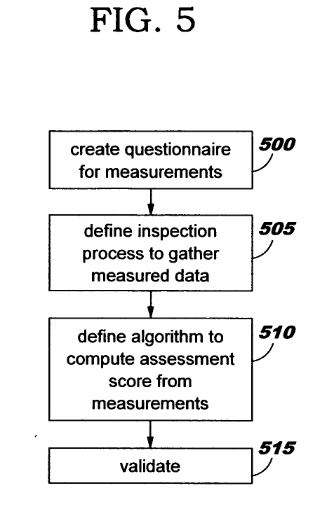

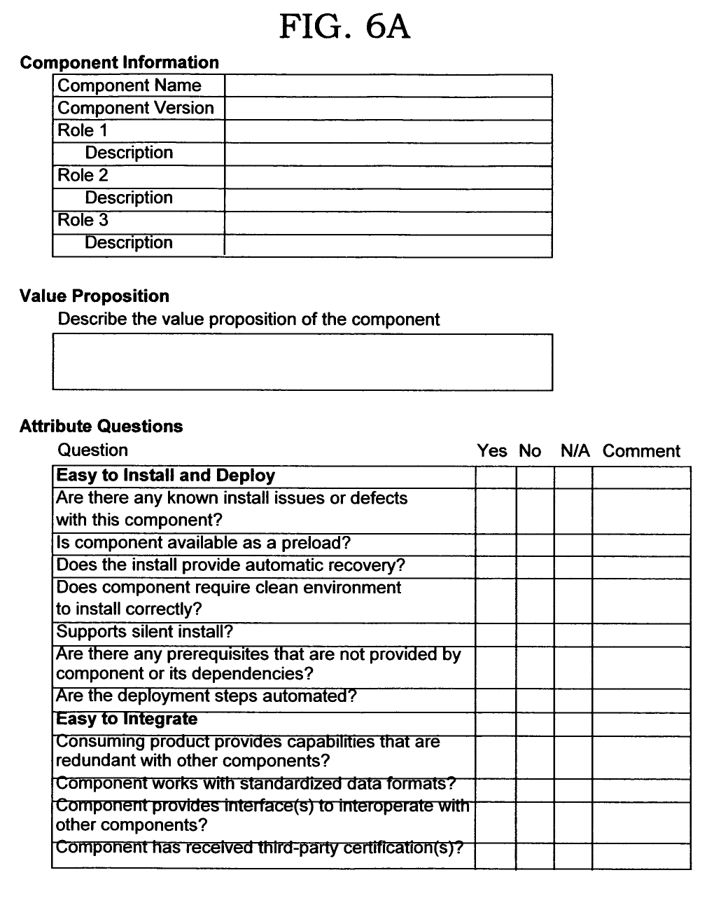

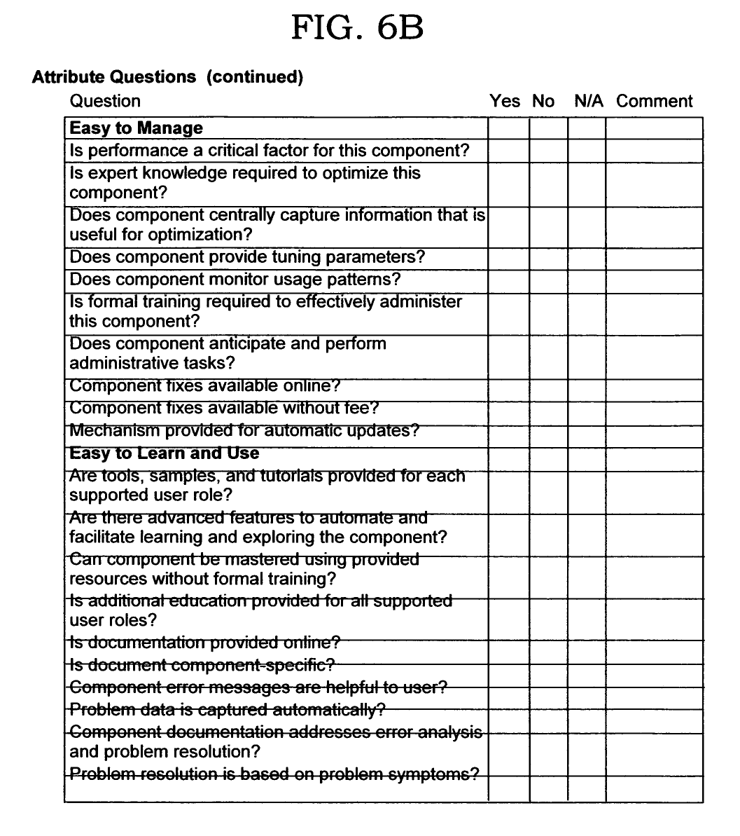

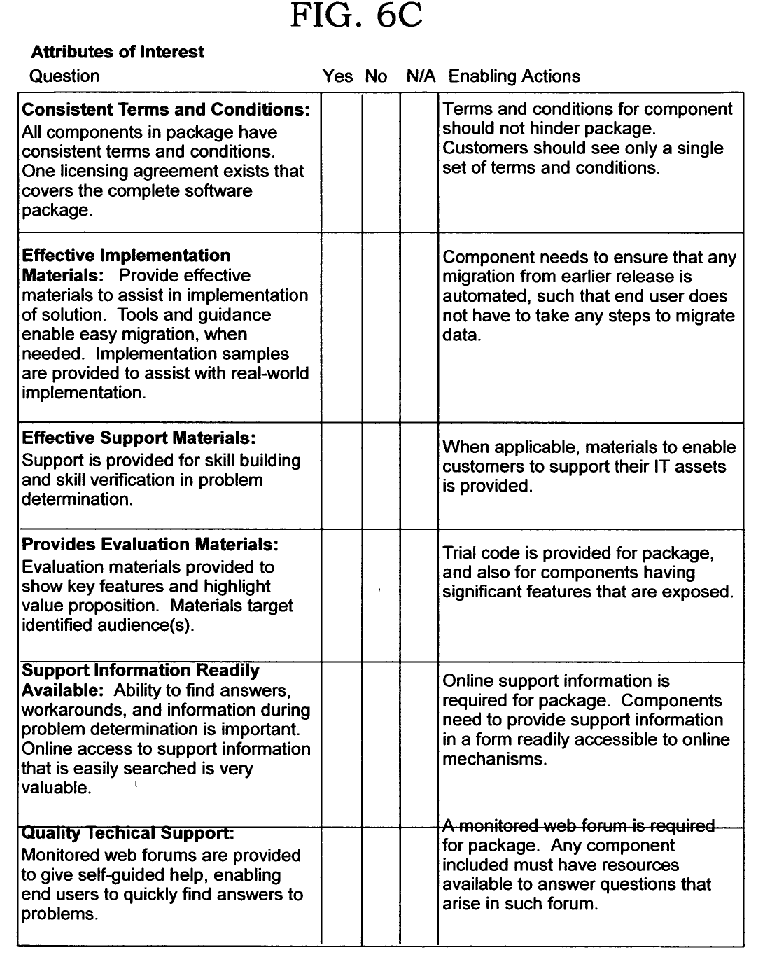

Referring now to FIG. 5, a flowchart is provided illustrating, at a high level, actions that are preferably carried out when establishing an assessment process according to the component assessment application. At Block 500, a questionnaire is preferably developed for use when gathering assessment data. Preferably, an initial written or electronic questionnaire is used to solicit information from the component team. See FIG. 6 for an example of a questionnaire that may be used for this purpose. An inspection process is preferably defined (Block 505), where this inspection process is to be used for information-gathering as part of the assessment. This inspection is preferably an independent evaluation, performed by a component assessment team that is separate and distinct from the component development team, during which further details and measurement data will be gathered.

An algorithm or computational steps are preferably developed (Block 510) to use the measurement data for computing a component assessment score. This algorithm may be embodied in a spread sheet or other automated technique.

One or more trial assessments may then be conducted (Block 515) for validation. For example, one or more existing components may be assessed, and the results thereof may be analyzed to determine whether an appropriate set of criteria, attributes, priorities, and deviations has been put in place. If necessary, adjustments may be made, and the process of FIG. 5 may be repeated in view of these adjustments. (An assessment process established according to FIG. 5 may be used when designing components, as has been discussed above with reference to FIG. 1.)

A component assessment may be performed in an iterative manner. This is illustrated in FIG. 7. Accordingly, assessments or assessment-related activities may be carried out at various checkpoints (referred to equivalently herein as “plan checkpoints”) during a component's design and development. First, as shown at element 700, assessment activities may be carried out while a component is still in the concept phase (i.e., at a concept checkpoint). In preferred embodiments, this comprises ensuring that the component team (“CT”) is aware of the criteria and attributes that will be used to assess the component, as well as informing them about the manner in which the assessment will be performed and its impact on their delivery and scheduling requirements. This provides a prescriptive approach to component development, whereby the component developers may be provided with a list or set of market-specific goals of the type discussed earlier (e.g., whereby a set of prescriptive statements is provided that specify what is required for a component to achieve particular attribute scores during an assessment).

When the component reaches the planning checkpoint, plan information is preferably used to conduct an initial assessment. This initial assessment is preferably conducted by the component development team, as a self-assessment, using the same criteria and attributes (and the same textual descriptions of how values will be assigned) as will be used by the component assessment team later on. See element 710. The component development team preferably uses its component development plans (e.g., the planned component features) as a basis for this self-assessment. Performing an assessment while an IT component is still in the planning phase may prove valuable for guiding a component development plan. Component features can be selected from among a set of candidates, and the subsequent development effort can then focus its efforts, in view of how this component (plan) assessment indicates that the wants and needs of the target market will be met.

As stated earlier, a component assessment score is preferably expressed as a numeric value. A minimum value for an acceptable score is preferably defined, and if the self-assessment at the planning checkpoint is lower than this minimum value, then in preferred embodiments, the component development team is required to revise its component development plan to raise the component's score and/or to request a deviation for one or more low-scoring attributes. Optionally, approval of the revised plan or a deviation request may be required.

Another assessment is then preferably performed during the development phase, as the component nears the end of the development phase (e.g., prior to releasing the component for consumption by products). This is illustrated in FIG. 7 by the availability checkpoint (see element 720), and a suitable score during this assessment may be required as an exit checkpoint before the component qualifies for release to (i.e., inclusion in) a component library. Preferably, this assessment is carried out by an independent team of component assessors, as discussed earlier. At this phase, the assessment is performed using the developed component and its associated information (e.g., documentation, related tools, and so forth). According to preferred embodiments, if deficiencies are found in the assessed component, then recommendations are provided and the component is revised. Therefore, it may be necessary to repeat the independent assessment more than once.

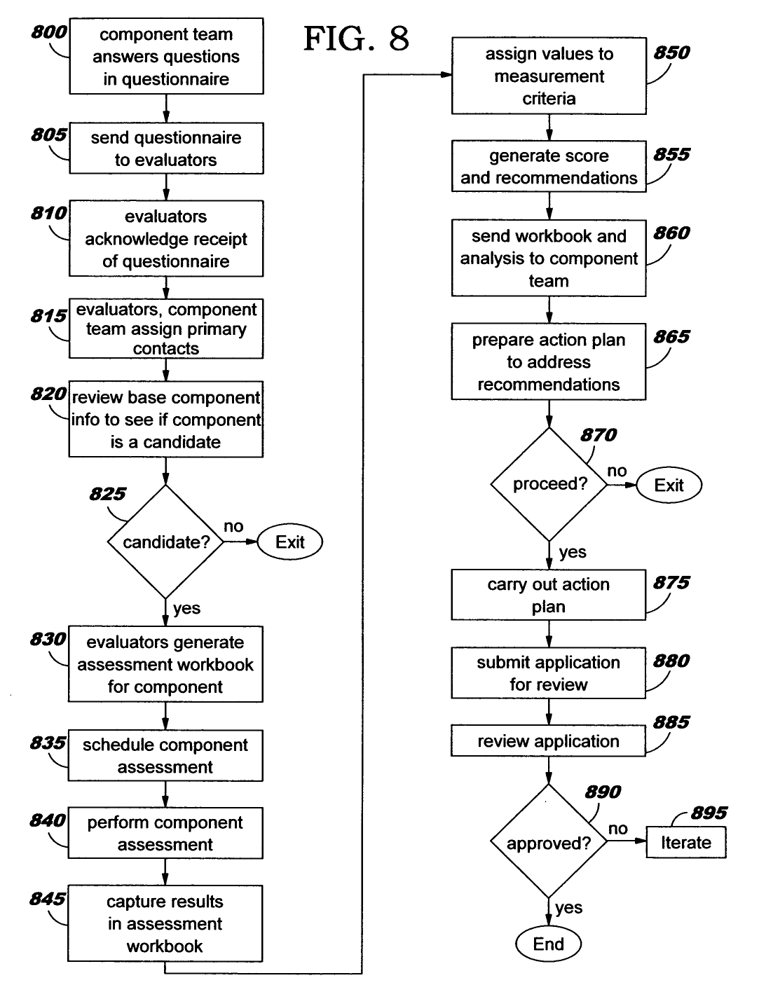

FIG. 8 provides a flowchart depicting, in more detail, how a component assessment may be carried out. The component team (e.g., planning team or development team, as appropriate) answers the questions on the assessment questionnaire that has been created (Block 800), and then submits this questionnaire (Block 805) to the assessors or evaluators. (FIG. 6 provides a sample questionnaire.) Optionally, the evaluators may acknowledge (Block 810) receipt of the questionnaire, and primary contact information may be exchanged (Block 815) between the component team and the evaluators.

The evaluators may optionally perform a review of basic component information (Block 820) to determine whether this component is a candidate for undergoing the assessment process. Depending on the outcome (Block 825), then the flow shown in FIG. 8 may exit (if the component is determined not to be a candidate) or it may continue at Block 830.

When Block 830 is reached, then this component is a candidate, and the evaluators preferably generate what is referred to herein as an “assessment workbook” for the component. The assessment workbook provides a centralized place for recording information about the component, and when assessments are performed during multiple phases (as discussed above), preferably includes the assessment information from each of the multiple assessments for the component. Items that may be recorded in the assessment workbook include planning information, competitive positioning of consuming products, comparative data for predecessor versions of a component, inspection findings, and/or assessment calculations.

At Block 830, the assessment workbook is preferably populated (i.e., updated) with initial information taken from the questionnaire that was submitted by the component team at Block 800. Note that some of the information on the questionnaire may directly generate measurement data, while for other information, further details are required from the actual component assessment. For example, the target platform service exploitation information discussed above with reference to FIG. 4 (including measurement guidelines 470) could be included on a component questionnaire, and answers from the questionnaire could then be used to assign a value from 1 to 5. For measurements related to installation or execution, such as how long it takes a novice user to learn a component's key functions, the questionnaire answers are not sufficient, and thus values for these measurements will be supplied later (e.g., during the inspection).

A component assessment is preferably scheduled (Block 835), and is subsequently carried out (Block 840). Performing the assessment preferably comprises conducting an inspection of the component, when carried out during the development phase, or of the component development plan, when carried out in the planning phase. When the operational component (or an interim version thereof) is available, this inspection preferably includes simulating a “first-use” experience, whereby an independent team or party (i.e., someone other than a development team member) receives the component in a manner similar to its intended delivery (for example, when a component is proposed for inclusion in a developer's toolkit, as some number of CD-ROMs, other storage media, or download instructions, and so forth) and then begins to use the functions of the component. (Note that when an assessment is performed using an interim version of a component, the scores that are assigned for the various attributes preferably consider any differences that will exist between the interim version and the final version, to the extent that such differences are known. Preferably, the component planning/development team provides detailed information on such differences to the component assessment team. If no operational code is available, then the inspection may be performed by review of code or similar documentation.)

Results of the inspection are captured (Block 845) in the assessment workbook. Values are assigned for each of the measurement attributes (Block 850), and these values are recorded in the assessment workbook. As discussed earlier, these values are preferably selected from a numeric range, such as 1 to 5, and textual descriptions are preferably defined in advance to assist the assessors in consistently applying the measurements to achieve an objective component assessment score.

Once the inspection has been completed and values are assigned and recorded for all of the measurement attributes, a component assessment score is generated (Block 855). The manner in which the score is computed, given the gathered information, may vary widely. One or more recommendations may also be generated, depending on how the component scores on particular attributes, to inform the component team where changes should be made to improve the component's score (and therefore, to improve the component's reusability and/or other factors such as what impact the component will have on acceptance of consuming products by their target market).

According to preferred embodiments, any measurement attribute for which the assigned value is 1 or 2 requires follow-up action by the component team, as these are not considered acceptable values. Thus, attributes receiving these values are preferably flagged or otherwise indicated in the assessment workbook. Preferred embodiments also require an overall score of at least 7 on a scale of 0 to 10, and any component scoring lower than 7 requires review of its assessment attributes and improvement before being approved for release and/or inclusion in a component library. (Overall scores and minimum required scores may be expressed in other ways, such as by using percentages values, without deviating from the scope of the present invention.) Optionally, selected attributes may be designated as critical or imperative for acceptance of this component's functionality in the target marketplace. In this case, even though a component's overall assessment score exceeds the minimum acceptable value, if it scores a 1 or 2 on a critical attribute, then review and improvement is required on these scores before the component can be approved.

When weights have been assigned to the various measurement attributes, then these weights may be used to prioritize the recommendations that result from the assessment. In this manner, actions that will result in the biggest improvement in the component assessment score can be addressed first.

The assessment workbook and analysis is then sent to the component team (Block 860) for their review. The component team then prepares an action plan (Block 865), as necessary, to address each of the recommendations. A meeting between the component assessors and representatives of the component team may be held to discuss the findings in the assessment workbook and/or the recommendations. The action plan may be prepared thereafter. Preferably, the actions from this action plan are recorded in the assessment workbook.

Assessment workbooks of the type described herein may be evaluated to determine “best practices” for various ones of the criteria, according to the information gathered during component assessments, and this information may be provided to component teams to be used in guiding the component development and/or in component design decisions. For example, “best practices” with regard to a particular attribute may be identified when a component scores a “5” on that attribute, and information may attribute was manifested in the component. Results recorded in the workbooks may be studied with regard to inhibitors of product success in the target market. This information may be used, in an iterative manner, when defining prescriptive statements that will guide component developers as they design and develop their components.

At Block 870, a test is made as to whether this component (or component plan) should proceed. If not (for example, if the component assessment score is too low, and sufficient improvements do not appear likely or cost-effective), then the process of FIG. 8 is exited. Otherwise, as shown at Block 875, the action plan is carried out. For example, if the component is still in the planning phase, then Block 875 may comprise selecting different features to be included in the component and/or redefining the existing features. If the component is in the development phase, then Block 875 may comprise redesigning function, revising documentation, and so forth, depending on where low attribute scores were assigned.

Block 880 indicates that, when the component's action plan has been carried out, an application for component approval may be submitted. This application is then reviewed (Block 885) by the appropriate person(s), who is/are preferably distinct from the assessment team, and if approved (i.e., the test at Block 890 has a positive result), then the process of FIG. 8 is complete. Otherwise, if Block 890 has a negative result, then the component's application is not approved (for example, because the component's assessment score is still too low, or the low-scoring attributes are not sufficiently improved, or because this is an interim assessment), and the process of FIG. 8 iterates, as shown at Block 895.

Optionally, a special designation may be granted to the component when the test in Block 890 has a positive result This designation may be used, for example, to indicate that this component has achieved at least some predetermined assessment score with regard to the assessment criteria, thereby enabling developers to consider this designation when selecting from among a set of candidate components provided in a component library or toolkit. A component that fails to meet this predetermined assessment score may still be released for reuse, but without the special designation. Furthermore, the test performed at Block 825 of FIG. 8 may be made with reference to whether the component's basic information indicates that this component is a candidate for receiving the special designation, and the decisions made at Block 870 and 890 may be made with reference to whether this component remains a candidate for, and should receive, respectively, the special designation.

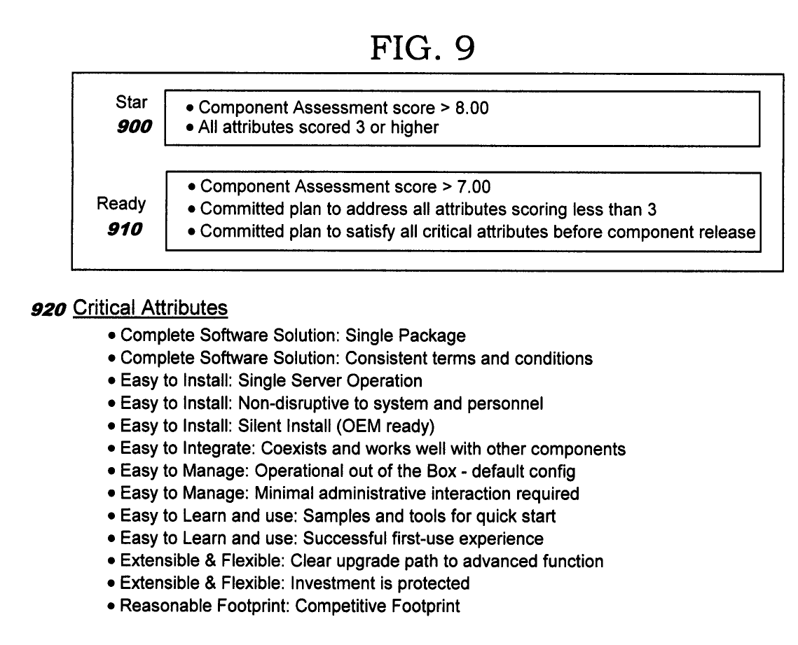

As stated earlier, a minimum acceptable assessment score is preferably specified for components to be assessed using the component assessment process. In addition to using this minimum score for determining when an assessed component is required either (i) to make changes and undergo a subsequent assessment and/or (ii) to justify its deviations, the minimum score may be used as a gating factor for receiving the special designation discussed above. Referring now to FIG. 9, an example is provided that illustrates how two different scores may be used for determining whether a component is ready for release and whether a component will receive a special designation. As shown therein (see element 900), a component may be designated as “star” if its overall component assessment score exceeds 8.00 (or some other appropriate score) and each of the assessed attributes has been assigned a value of 3 or higher on the 5-point scale. Or, the component may be designated as “ready” (see element 910) if the following criteria are met: (1) its overall component assessment score exceeds 7.00; (2) a committed plan has been developed that addresses all attributes scoring lower than 3 on the 5-point scale; and (3) a committed plan is in place to satisfy, before release of the component, all attributes that have been determined to be “critical”. In this example, the “ready” designation indicates that the component has scored high enough to be released, whereas the “star” designation indicates that the component has also score designation. (Alternative criteria for assigning a special designation to a component may be defined, according to the needs of a particular environment in which the assessment process is used.)

Element 920 provides a sample list of criteria and attributes that have been identified as critical. In this example, 7 of the 8 measurement criteria from FIG. 2 are represented. (That is, a critical attribute has not been identified for the target market platform support” category.) For these 7 criteria, 13 different attributes are identified as critical. By comparing the list at 920 to the attributes identified in FIG. 2, it can be seen that there are a number of attributes that are considered important for measuring, but that are not considered to be critical. Preferably, the identification of critical attributes is substantiated with market intelligence or consumer feedback. This list may be revised over time, as necessary, to keep pace with changes in that information. When weights are assigned to attributes for computing a component's assessment score, as discussed above, a relatively higher weight is preferably assigned to the attributes appearing on the critical attributes list.

FIG. 10 shows a sample component assessment report 1000 where two aspect 1020, 1030 of a hypothetical “Widget” component have been assessed and scored. Preferably, a report is prepared after each assessment, and provides information that has been captured in the assessment workbook. A “measurement criteria” column 1010 lists criteria which were measured, and in this example, the criteria are provided in a summarized form. (As an alternative, a report may be provided that gives details of each individual attribute measured for each of the criteria) Note that the sample report in FIG. 10 uses identical weights for each of the measurement criteria for each of the assessed aspects. This is by way of illustration only, and in preferred embodiments, variable weights are supported to enable the computed assessment scores to reflect importance of each of the criteria.

For each assessed aspect, the assessment report indicates how that component scored for each of the criteria (see the “Score” columns), the weight assigned to prioritize that criterion (see the “Wt.” columns), and the contribution that this weighted criterion assessment makes to the overall assessment score for this aspect (see the “Contr.” columns). In preferred embodiments, an algorithm is then used to produce the overall aspect assessment score from the weighted criteria contributions. In this example, the “Widget Runtime” aspect 1020 has an assessment score of 3.50 (see 1040) and the “Widget Development Tools” aspect 1030 has an assessment score of 4.25 (see 1050).

FIG. 11 shows a sample summary report 1100 providing an example of summarized assessment results for an assessed component named “Component XYZ”. As shown at element 1110, the component's overall assessment score is listed. In this example, the assessed component has received an overall score of 8.65. Furthermore, the assessment summary report for this component provides assessment scores for two other components, “Component ABC” and “Acme Computing component”, which presumabl capabilities as “Component XYZ”. Using the same measurement criteria and attributes, these products received scores of 6.89 and 7.23, respectively. Thus, the component team may be provided with an at-a-glance view of how their component compares to other components providing the same functional capabilities. This allows the component team to determine how well their component will be received, and when the score is lower than the required minimum, to gauge the amount of rework that will be necessary before the component should be released for consumption.

A summary 1120 is also provided, listing each of the attributes that did not achieve the minimum acceptable score (which, in preferred embodiments, is a 3 on the 5-point scale, as stated above). In this example, one attribute of the “Easy to Learn and Use” criterion (see 1121) failed to meet this minimum score. In the example report, the actual score assigned to the failing attribute is presented, along with an impact value and comments. The impact value indicates, for each failing attribute, how much of an improvement to the overall assessment score would be realized if this attribute's score was raised to the minimum score of 3. For each attribute in this summary 1120, the assessment team preferably provides comments that explain why the particular attribute value was assigned. Thus, as shown in this example (see 1122), an improvement of .034 could be realized in the component's assessment score (from a score of “2”) if samples were provided for some function “PQR”.

A recommended actions summary 1130 is also provided, according to preferred embodiments, notifying the component team as to the assessment team's recommendations for improving the component's score. In this example, a recommended action has been provided for the attribute 1121 that did not meet requirements.

Preferably, the attributes in summary 1120 and the corresponding actions in summary 1130 are listed in decreasing order of potential improvement in the assessment score. This prioritized ranking is beneficial to the component development team, as it allows them to prioritize their efforts for revising the component in view of where the most significant gains can be made in the component's assessment score. (Preferably, attribute weights are used in deterning the impact values shown for each attribute in summary 1120, and these impact values are then used for the prioritization.)

Additionally, more-detailed information may also be included in assessment reports, although this detail has not been shown in the sample report 1100. Preferably, the summary information shown in FIG. 11 is accompanied by a complete listing of all attributes that were measured, the measurement values assigned to those attributes, and any comments provided by the assessment team (which may be in a form such as sample report 1000 of FIG.10). If this component has previously undergone an assessment and is being reassessed as to improvements that have been made, then the earlier measurement values are also preferably provided. Optionally, where critical attributes have been defined, these attributes may be visually highlighted in the report.

As has been demonstrated, the present invention defines advantageous techniques for market-driven design of IT components. Importance of various attributes to the target market are reflected when specifying prescriptive statements for guiding the component development process, and components are preferably assessed to predict how well they will meet requirements of their target market.

As will be appreciated by one of skill in the art, embodiments of the present invention may be provided as methods, systems, or computer program products comprising computer-readable program code. Accordingly, the present invention may take the form of an entirely hardware embodiment, an entirely software embodiment, or an embodiment combining software and hardware aspects. The computer program products maybe embodied on one or more computer-usable storage media (including, but not limited to, disk storage, CD-ROM, optical storage, and so forth) having computer-readable program code embodied therein.

When implemented by computer-readable program code, the instructions contained therein may be provided to a processor of a general purpose computer, special purpose computer, embedded processor, or other programmable data processing apparatus to produce a machine, such that the instructions, which execute via the processor of the computer or other programmable data processing apparatus, create means for implementing embodiments of the present invention.

These computer-readable program code instructions may also be stored in a computer-readable memory that can direct a computer or other programmable data processing apparatus to function in a particular manner, such that the instructions stored in the computer-readable memory produce an article of manufacture including instruction means which implement embodiments of the present invention.

The computer-readable program code instructions may also be loaded onto a computer or other programmable data processing apparatus to cause a series of operational steps to be performed on the computer or other programmable apparatus to produce a computer-implemented method such that the instructions which execute on the computer or other programmable apparatus provide steps for implementing embodiments of the present invention.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

1. A method of designing information technology (“IT”) components, comprising steps of:
determining a plurality of criteria that are important to a target market, and at least one attribute to be used for measuring each of the criteria;
specifying objective measurements for each of the attributes, thereby identifying values that are assignable to each attribute from a multi-valued scale;
specifying prescriptive statements that identify, for at least one of the attributes, actions required to achieve at least one of the identified values from the multi-valued scale; and
using the specified prescriptive statements to determine what functionality to include in an IT component.

2. The method according to claim 1, further comprising the steps of:
conducting an evaluation of the IT component, further comprising the steps of:
inspecting a representation of the IT component, with reference to selected ones of the attributes;
assigning attribute values from the multi-valued scale to the selected attributes, according to how the IT component compares to the specified objective measurements; and
using the assigned attribute values to compute an assessment score for the component; and
if the computed assessment score fails to meet a predetermined threshold, revising the IT component to improve the computed assessment score.

3. The method according to claim 1, wherein the recording step further comprises recording, for any attribute of the selected IT component for which the assigned attribute value achieves a highest of the assignable values on the multi-valued scale, information describing how the attribute is manifested in the component.

4. The method according to claim 3, further comprising the step of collecting, for the conducted evaluations, the recorded information.

5. The method according to claim 3, wherein the recorded information is collected automatically, responsive to the highest of the assignable values being assigned.

6. The method according to claim 4, wherein the recorded information is collected from an electronic version of one or more component assessment workbooks, each workbook recording the assigned attribute values from the inspection of one or more of the IT components.

7. The method according to claim 4, further comprising the step of using the collected information to revise at least one of the prescriptive statements.

8. The method according to claim 4, further comprising the step of using the collected information as input when designing revisions to the IT component.

9. The method according to claim 4, further comprising the step of using the collected information as input when designing other IT components.

10. A system for designing information technology (“IT”) components for their target market, comprising:
a plurality of criteria that are important to a target market, and at least one attribute to be used for measuring each of the criteria;
objective measurements that are specified for each of the attributes, thereby identifying values that are assignable to each attribute from a multi-valued scale;
prescriptive statements that identify, for at least one of the attributes, actions required to achieve at least one of the identified values from the multi-valued scale;
means for using the specified prescriptive statements to determine what functionality to include in an IT component; and
means for conducting an evaluation of the IT component, wherein the means for conducting each evaluation further comprises:
means for inspecting a representation of the IT component, with reference to selected ones of the attributes;
means for assigning attribute values from the multi-valued scale to the selected attributes, according to how the IT component compares to the specified objective measurements; and
means for computing an assessment score for the IT component using, for each of the selected ones of the attributes, the assigned attribute value.

11. The system according to claim 10, further comprising:
means for allowing the IT component to be released for reuse only if the computed assessment score meets or exceeds a predetermined threshold.

12. A computer program product for designing information technology (“IT”) components, the computer program product embodied on one or more computer-readable media and comprising computer-readable instructions that, when executed on a computer, cause the computer to:
record results of conducting an evaluation of a plurality of IT components, wherein each of the evaluations further comprises:
inspecting a representation of a selected one of the IT components, with reference to selected ones of a plurality of attributes, wherein the attributes are defined to measure the IT components in view of a plurality of criteria;
assigning attribute values from a multi-valued scale to each of the selected attributes, according to how the selected IT component compares to objective measurements which have been specified for each of the attributes; and
means for recording, for each of the attributes, a value achieved by the selected IT component from the multi-valued scale; and
programmatically collect the recorded information.
